(19) United States
(12) Patent Application Publication
(10) Pub. No.: US 2008/0261042 A1
(43) Pub. Date: Oct. 23, 2008

(54) FIBER REINFORCED REBAR

(76) Inventor: Randel Brandstrom, Edmonton (CA)

Correspondence Address: ADE & COMPANY INC., 2157 Henderson Highway, WINNIPEG, MB, R2G1P9, CA

(21) Appl. No.: 11/738,808

(22) Filed: Apr. 23, 2007

(51) Int. Cl. B32B 17/10

(52) U.S. Cl. 428/375

(57) ABSTRACT

A composite reinforcing bar is formed by providing a reinforcing material supply of fiber strands rovings; a resin supply bath, and a puller for pulling the resin-impregnated reinforcing material through the resin bath. The reinforcing fibers include a series of inner rovings longitudinal to the bar with a first and a second helical wrappings of at least one roving wrapped around the inner rovings in opposed directions of wrapping. The resin is permeated through both the inner rovings and through the wrapped rovings to the outer surface where the inner rovings having parts thereof between the first and second wrapped rovings exposed and bulged outwardly by tension applied by the wrappings during curing with the bulged parts defining components of the outer surface portion of the bar which are thus rough and exposed for engaging a material to be reinforced so as to transfer longitudinal loads between the material to be reinforced and the inner rovings.

The present invention relates a method for manufacture of fiber reinforced reinforcing bar or “rebar”.

The term “rebar” as used herein is intended to include bars and rods which are hollow, that is tubing. The outside surface is preferably but not necessarily of circular cross section. The rods can be of any length including elements which are relatively short so that they are sometimes referred to as “bolts”.

### BACKGROUND OF THE INVENTION

The use of fiber reinforced plastics (FRP) rods in construction, marine, mining and others has been increasing for years. This is because FRP has many benefits, such as non-(chemical or saltwater) corroding, non-metallic (or non-magnetic) and non-conductive, about twice to three times tensile strength and ¼ weight of steel reinforcing rod, a co-efficient of thermal expansion more compatible with concrete or rock than steel rod. Most of the bars are often produced by pultrusion process and have a linear or uniform profile. Conventional pultrusion process involves drawing a bundle of reinforcing material (e.g., fibers or fiber filaments) from a source thereof wetting the fibers and impregnating them (preferably with a thermo-settable polymer resin) by passing the reinforcing material through a resin bath in an open tank, pulling the resin-wetted and impregnated bundle through a shaping die to align the fiber bundle and to manipulate it into the proper cross sectional configuration, and curing the resin in a mold while maintaining tension on the filaments. Because the fibers progress completely through the pultrusion process without being cut or chopped, the resulting products generally have exceptionally high tensile strength in the longitudinal direction (i.e., in the direction the fiber filaments are pulled). Exemplary pultrusion techniques are described in U.S. Pat. No. 3,793,108 to Goldsworthy; U.S. Pat. No. 4,394,338 to Fuwa; U.S. Pat. No. 4,445,957 to Harvey; and U.S. Pat. No. 5,174,844 to Tong.

FRP uniform profile or linear rods offer several advantages in many industrial applications. The rods are corrosion resistant, and have high tensile strength and weight reduction. In the past, threaded steel rods or bolts had been widely used in engineering practice. However, long-term observations in Sweden of steel bolts grouted with mortar have shown that the quality of the grouting material was insufficient in 50% of the objects and more bolts have suffered from severe corrosion (see reference Hans K. Helfrich). In contrast with the steel bolts, the FRP bolts are corrosion resistant and can be simultaneously used in the temporary support and the final lining, and the construction costs of single lining tunnels with FRP rock bolts are 33% to 50% lower than of tunnels with traditional in-site concrete (see reference Amberg Ingenieurburo AG, Zurich). This FRP rock bolting system is durable and as a part of the final lining supports a structure during its whole life span. Furthermore, due to their seawater corrosion resistance, the FRP bolts and anchors are also proven as good solutions in waterfront (e.g., on-shore or off-shore seawalls) to reinforce the concrete structures. In general the fibreglass rod/bolt is already an important niche, and will be a more important product to the mining and construction industries. The critical needs of these industries are for structural reinforcements that provide long-term reliability that is of cost-effective. The savings in repair and maintenance to these industries will be significant, as the composite rebar will last almost indefinitely.

The mining industry requires composite rods for mining shafts or tunnel roof bolts. These rods are usually carried by hand and installed overhead in mining tunnel, so there is a benefit that the fibreglass rod is ¼ the weight and twice the strength of steel rebar which are widely used currently. Fibreglass rod also does not damage the mining equipment. In construction industries, such as bridges, roads, seawall and building structures, reinforcements of the steel rebar have been widely used and the most of steel rebars have been corroded after a few years of service life. Typically, the structures with the steel rebars are often torn down after a period of time. Therefore, the use of the corrosion resistant composite rebars have been increased for construction industries in recent years.

Non-uniform profile or non linear threaded rods are also required in many industrial applications. For example, threaded FRP rods and associated nuts have been used as rock bolting system in mining industries (e.g., for tunnel roof bolts), as threaded reinforcing rebar structures in construction industries (e.g., in bridge construction), as well as seawall bolting system in marine structures.

The structures of the threaded composite rods from existing manufacturing technology consist of two styles:

(1) Pultruded rod with machined threads in outside surface, and

(2) Pultruded rod has a core of fiber rovings with plastic materials molded outside the core to form threads.

In style (1), the problem of machining composite rebar surface after it is fully cured is that the fibers in a depth of surface are cut into segments. The benefit of high tensile strength of the fibers are lost when they are cut into short lengths. The strength of the threads now rely on the shear strength of the cured resin which is much less than that of the fibers. Thus, the rebar could not be used under tension since the threads of the rebar will shear away from the core. The rebar uses a specially designed nut that compresses against the rebar to give it holding strength when a load is placed on the rebar. The nut threaded onto the rebar has just enough resistance to take up any slack between the nut and the thread surface. Therefore the nut is used without pre-tension.

In style (2), the rebar has a core of fiber glass rovings and a plastics molded threads surface. This rebar is only capable of withstanding a small amount of longitudinal loads. This is because the threads formed by the molded plastics lack the fiber glass reinforcements for having the longitudinal strength. Other rebars, such as those shown in a brochure by Marshall Industries Composites Inc C-BAR 1996, are a combination of a fiber-reinforced polyester core and a urethane-modified vinyl ester outer skin, which do not include the thread features in rebar surface.

There is therefore a need in mining, construction and other industries for composite rod and nut fastening system that the rod and nut have a fully threaded feature without the disadvantages of the style (1) and (2) described in the paragraph above.

### SUMMARY OF THE INVENTION

It is one object of the present invention to provide a novel reinforcing bar formed from fiber reinforced resin.

According to a first aspect of the invention there is provided a reinforcing bar comprising:

a series of inner rovings of reinforcing fibers arranged longitudinal to the bar;

a first helical wrapping of at least one roving wrapped around the inner rovings in a first direction of wrapping;

a second helical wrapping of at least one roving wrapped around the inner rovings in a second opposed direction of wrapping;

a resin permeated through both the inner rovings and through the wrapped rovings to form a structure integrated by the permeated resin;

the bar having an outer surface portion which extends along at least most of the length of the bar;

at the outer surface portion, the inner rovings having parts thereof between the first and second wrapped rovings exposed and bulged outwardly by tension applied by the wrapped rovings during curing;

the bulged parts defining components of the outer surface portion of the bar which are thus rough and exposed for engaging a material to be reinforced so as to transfer longitudinal loads between the material to be reinforced and the inner rovings.

Preferably the resin is exposed on the outside surfaces of the inner rovings and the wrapped rovings.

Preferably the outside surface portion is free from bonded exterior roughening elements attached onto the outside surface of the resin.

Preferably, at the outer surface portion, the resin is cured while the inner and wrapped rovings are free from external pressure such that the shape of the outer surface is defined solely by the shape of the inner and wrapped rovings as the resin is cured. Preferably the bar includes at least one additional outer surface portion where the resin and the inner rovings and the wrapped rovings are compressed to form a polygonal cross section for engaging a correspondingly shaped chuck by which the bar can be rotated about a longitudinal axis of the bar.

According to a second aspect of the invention there is provided a reinforcing bar comprising:

a series of inner rovings of reinforcing fibers arranged longitudinal to the bar;

a first helical wrapping of at least one roving wrapped around the inner rovings in a first direction of wrapping;

a second helical wrapping of at least one roving wrapped around the inner rovings in a second opposed direction of wrapping;

a resin permeated through both the inner rovings and through the wrapped rovings to form a structure integrated by the permeated resin;

the bar having an outer surface along the full length of the bar;

at the outer surface, the inner rovings having parts thereof between the first and second wrapped rovings exposed and bulged outwardly by tension applied by the wrapped rovings during curing;

the bulged parts defining components of the outer surface portion of the bar which are thus rough and exposed for engaging a material to be reinforced so as to transfer longitudinal loads between the material to be reinforced and the inner rovings.

According to a third aspect of the invention there is provided a reinforcing bar comprising:

a series of inner rovings of reinforcing fibers arranged longitudinal to the bar;

a first helical wrapping of at least one roving wrapped around the inner rovings in a first direction of wrapping;

a second helical wrapping of at least one roving wrapped around the inner rovings in a second opposed direction of wrapping;

a resin permeated through both the inner rovings and through the wrapped rovings to form a structure integrated by the permeated resin;

the bar having a first outer surface portion which extends along a first part of the length of the bar;

the bar having at least one second outer surface portion which extends along a second part of the length of the bar;

wherein at the at least one second outer surface portion, the resin and the inner rovings and the wrapped rovings are compressed to form a polygonal cross section for engaging a correspondingly shaped chuck by which the bar can be rotated about a longitudinal axis of the bar.

### BRIEF DESCRIPTION OF THE DRAWINGS

FIG. 1 is a side elevational view of a portion of a reinforcing bar according to the present invention.

FIG. 2 is a cross sectional view along the lines 2-2 of FIG. 1.

FIG. 3 is a cross sectional view similar to that of FIG. 2 on an enlarged scale.

FIG. 4 is a cross sectional view along the lines 44 of FIG. 1.

### DETAILED DESCRIPTION OF THE INVENTION

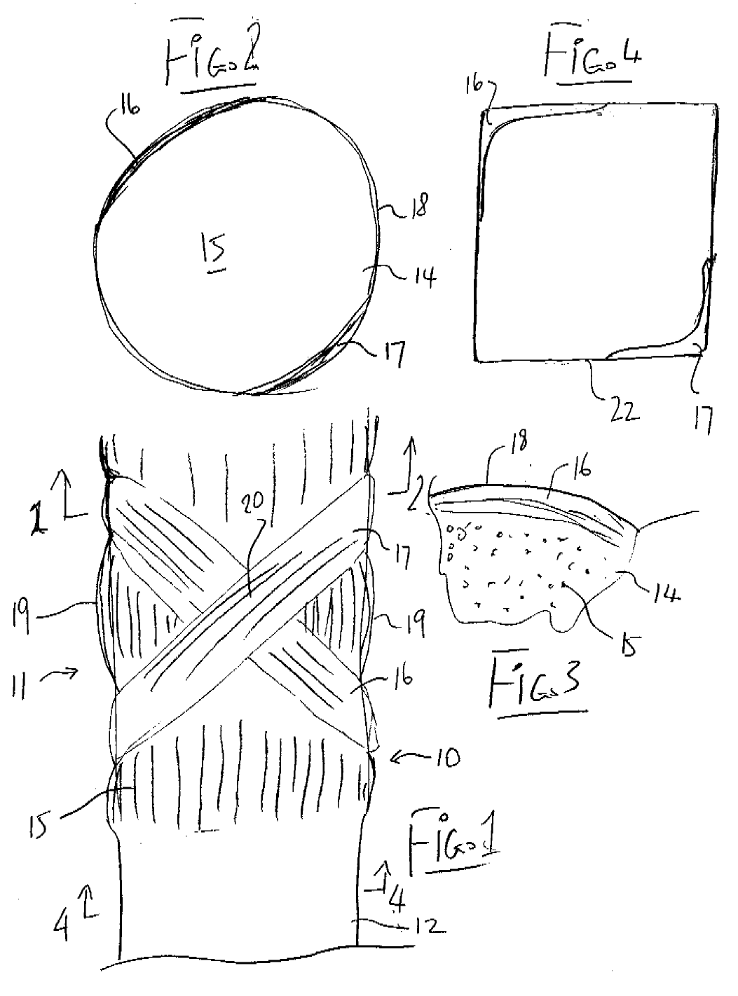

In FIG. 1 is shown a reinforcing bar generally indicated at 10 which has a first section 11 extending along most of the length of the bar together with a second section 12 which extends a part of the length of the bar. The bar is generally formed in continuous construction so that the first and second sections are repeated alternately. The length of the second section generally will comprise only a short portion relative to the length of the main section 1 so that for example the main section may be 12 feet long and the second section only 6″ long.

The reinforcing bar is formed solely from a resin material 14 which is permeated through to sections of reinforcing fibers including longitudinal reinforcing fibers 15 and wrapping reinforcing fiber 16, 17.

The longitudinal reinforcing fibers 15 constitute the main volume of the structure so that typically the fiber content may be constituted as longitudinal fibers 90 to 97% and wrapping fibers 3 to 10%, where the resin content can be of the order of 20 to 30% by weight.

The structure in the area of the portion 11 is formed without any compression of any of the fibers by a pultrusion process. Thus neither the inner core formed by the longitudinal fibers 15 nor the outer wrapping 16 and 17 pass through a die structure so that they are free to take up their positions as determined by the tensions in the material when formed.

The resin may be a two part resin which sets without heat but more preferably is a thermosetting resin which is heated by any one of a number of available heating techniques such as microwave heating, forced air heating, infra-red heating, RF-heating, or induction heating where at least one metal fiber is included in the structure to absorb the electromagnetic energy. Thus the heat is applied to the structure to effect curing of the resin without contact by the heating device on the structure. In this way the fibers in the first section 11 are free to take up their position depending upon their tension and they take up a position within the resin so that the resin extends both through the longitudinal fibers and the wrapping fibers.

In order to obtain this situation where the resin 14 extends outwardly to the outer surface 18 and permeates through all of the fibers, the longitudinal fibers and the wrapping fibers are both preferably wetted preferably using a bath or dipping process so that the fibers are fully enveloped with the resin prior to entry into the forming system generally described above and shown in more detail in the above US patent of the present inventor, the disclosure which is incorporated herein by reference.

The wetting of the fibers ensures that the resin permeates through the whole structure of the outside surface 18.

The absence of any compression by the provision of any form of die through which the core of longitudinal fibers passes ensures that the wrapping fibers 16 and 17 apply pressure onto those parts of the longitudinal fibers which are contacted by the wrapping fibers squeezing those longitudinal fibers inwardly and causing bulging of the longitudinal fibers in the sections 19. Thus between each wrapped strip of fibers there is a portion of the longitudinal fibers which is squeezed and bulged outwardly so that it projects to a position which is preferably slightly proud of the outside surface of the wrapping fibers.

The wrapping fibers are of course spaced in the longitudinal direction by a helical wrapping action so that the width of the wrapping fibers is less than the width of the bulged intermediate sections 19.

Typically the wrapping fibers in each direction can be spaced of the order of 1 to 3 to the inch. However a wider or lesser spacing may be used provided the longitudinal fiber are properly controlled and provided there is enough space to ensure bulging between the wraps.

The wrapping fibers may be wrapped as a single roving in a single start wrapping process or as multiple rovings applied in a multi-start wrapping process. In such a multi start process the number of rovings side by side may be in the range 3 to 10. The number of rovings or the thickness of the roving at the wrapping position may vary depending on the diameter of the core.

The wrapping action occurs in both directions so that the wrapping fibers overlap one another as they cross as shown for example at 20. In this way the bulged sections are generally diamond shape in front elevation and are squeezed at the top and bottom by the wrapping action of the wrapping fibers. Thus the bulging sections 19 are individual and separated by the wrapping fibers and yet the longitudinal fibers are properly contained and held into the structure by the wrapping at top and bottom of the bulging sections.

The provision of the wrapping or wrappings symmetrically in both directions tends to contain and locate the inner longitudinal rovings and maintain them in the longitudinal direction even when tension is applied. Thus the full strength of the longitudinal fibers in the longitudinal direction is maintained and is not reduced or compromised by any tendency of the longitudinal fibers to twist. Any such twisting of the longitudinal fibers can significantly reduce strength by applying loads sequentially to different fibers leading to sequential failure. In addition the wrappings in opposite directions accommodate torque applied to the rod in both directions.

The bulging sections 19 are thus presented on the outside surface 18 for engagement with material within which the bar is embedded. Thus if the material to be reinforced is concrete, the concrete sets around the reinforcing bar and engages the bulging sections 19. Longitudinal loads from the concrete to the reinforcing bar are therefore transferred to the bulging sections 19 and not only to the wrapping section 16 and 17. The wrapping sections because of their angle to the longitudinal direction have less ability to accommodate longitudinal tension than do the longitudinal fibers which are longitudinal and continuous. Thus transferring the loads in the longitudinal direction to the bulged sections 19 ensures that the loads are transferred into the longitudinal fibers and avoid transference to elements which can be moved longitudinally or stripped from the outside surface 18. The bulge sections 19 cannot of course move longitudinally since they are part of longitudinal fibers.

Yet the outside surface thus can be free from additional bonded projecting elements such as grit or sand which is commonly applied to the outside surface of such reinforcing bars. The fact that the resin is permeated throughout both the longitudinal fibers and the wrapping fibers to the outside surface 18 ensures that the wrapping fibers are bonded effectively into the structure.

The second section 12 is formed periodically along the bar as it is formed by clamping the portion of the bar within a clamping die. The clamping die may move with the structure as it moves forwardly or the movement could be halted while the clamping action occurs and the curing occurs in the clamped position. Generally the formation of the clamped section occurs before the remainder of the bar moves into the heating section to complete the curing action. The clamping die has an inside surface which is shaped to a polygonal shape such as square and squeezes both the wrapping fibers and the longitudinal fibers to form them into the required outer shape 22 as shown in FIG. 4. The clamping action squeezes the fibers together and may reduce the cross sectional area due to squeezing of the resin from the structure. The longitudinal fibers extend through the clamp section and also the wrapping fibers extend through the clamp section as shown in FIG. 4. Thus the wrapping fibers in both directions of wrap are clamped into the structure at the polygonal second section 12.

As an alternative to the polygonal shape, any other non-circular shape may be used such as a compressed flat shape.

As a further alternative the rough rebar may be formed with a hole through the fibers to provide a connection for an anchor.

The second section 12 is thus shaped so that the bar can be grasped by a chuck or other clamping element so that the bar can be rotated around its axis during insulation of the bar in particular circumstances. The wrapping of the fibers 16 and 17 ensures that rotation at the second section 12 is transmitted into torque throughout the length of the bar by those wrapped section 16 and 17.

In one example of use of an arrangement of this type, the bar can be inserted into a drilled hole in rock in a mining situation and the drilled hole filled with a suitable resin. The stirring action in the resin caused by the rotation of the bar grasping the second section 12 and rotating the first section 11 causes the resin to be spread through the hole around the periphery in an effective stirring action caused by the bulged sections 19. Thus the bar can be bonded into place within the drilled hole to act as reinforcement for mining structures at for example the roof area of a mine.

In another alternative use of reinforcing bars of this type, a drill tip can be attached at one section 12 and the bar grasped at another section 12 allowing the bar to be rotated with the drill tip causing a drilling action driving the bar directly into a drilled hole while the bar causes the drilling of the hole. The bar can then remain in place and the drill tip selected be of a sufficiently disposable type so that it can be discarded within the hole.

Again the direct connection between the polygonal section 12 and the main portion of the bar caused by the presence of the wrapping fibers 16 and 17 within the resin allows the transfer of loads between the polygonal section and the main section 11.

The arrangement described herein has been found to be significantly advantageous in that it provides an improved embedment strength which is a factor used in calculating parameters for reinforcing bars in concrete. Thus the shape of the outer surface (wrappings in both directions, bulging of the longitudinal strands) provides a higher degree of attachment with the adhering material (concrete or epoxy resin). This higher mechanical bond translates into a high embedment strength.

The arrangement described herein has been found to be significantly advantageous in that it provides an improved control of crack width. Measurement of crack width is another factor used in calculating parameters for reinforcing bars in concrete with the intention of maintaining a low crack width factor. When designing for crack control reinforcement, the nature of this product and its high embedment strength will allow for a smaller bond dependent co-efficient to be used (for example, sand coated bars use 0.8, and a smooth pultruded bar would be higher). A lower bond dependant co-efficient translates into smaller crack widths, or less reinforcement required for the same crack width.

1. A reinforcing bar comprising:
a series of inner rovings of reinforcing fibers arranged longitudinal to the bar;
a first helical wrapping or wrappings of at least one roving wrapped around the inner rovings in a first direction of wrapping;
a second helical wrapping or wrappings of at least one roving wrapped around the inner rovings in a second opposed direction of wrapping;
a resin permeated through both the inner rovings and through the wrappings to form a structure integrated by the permeated resin;
the bar having an outer surface portion which extends along at least most of the length of the bar;
at the outer surface portion, the inner rovings having parts thereof between the first and second wrapping or wrappings exposed and bulged outwardly by tension applied by the wrapping or wrappings during curing;
the bulged parts defining components of the outer surface portion of the bar which are thus rough and exposed for engaging a material to be reinforced so as to transfer longitudinal loads between the material to be reinforced and the inner rovings.

2. The reinforcing bar according to claim 1 wherein the resin is exposed on the outside surfaces of the inner rovings and the wrapped rovings.

3. The reinforcing bar according to claim 2 wherein the outside surface portion is free from bonded exterior roughening elements attached onto the outside surface of the resin.

4. The reinforcing bar according to claim 1 wherein, at the outer surface portion, the resin is cured while the inner and wrapped rovings are free from external pressure such that the shape of the outer surface is defined solely by the shape of the inner and wrapped rovings as the resin is cured.

5. The reinforcing bar according to claim 1 wherein the bar includes at least one additional outer surface portion where the resin and the inner rovings and the wrapped rovings are compressed to form a polygonal cross section for engaging a correspondingly shaped chuck by which the bar can be rotated about a longitudinal axis of the bar.

6. A reinforcing bar comprising:
a series of inner rovings of reinforcing fibers arranged longitudinal to the bar;
a first helical wrapping or wrappings of at least one roving wrapped around the inner rovings in a first direction of wrapping;
a second helical wrapping or wrappings of at least one roving wrapped around the inner rovings in a second opposed direction of wrapping;
a resin permeated through both the inner rovings and through the wrappings to form a structure integrated by the permeated resin;
the bar having an outer surface along the full length of the bar;
at the outer surface, the inner rovings having parts thereof between the first and second wrapping or wrappings exposed and bulged outwardly by tension applied by the wrapping or wrappings during curing;
the bulged parts defining components of the outer surface portion of the bar which are thus rough and exposed for engaging a material to be reinforced so as to transfer longitudinal loads between the material to be reinforced and the inner rovings.

7. A reinforcing bar comprising:
a series of inner rovings of reinforcing fibers arranged longitudinal to the bar;
a first helical wrapping or wrappings of at least one roving wrapped around the inner rovings in a first direction of wrapping;
a second helical wrapping or wrappings of at least one roving wrapped around the inner rovings in a second opposed direction of wrapping;
a resin permeated through both the inner rovings and through the wrappings to form a structure integrated by the permeated resin;
the bar having a first outer surface portion which extends along a first part of the length of the bar;
the bar having at least one second outer surface portion which extends along a second part of the length of the bar;
wherein, at the at least one second outer surface portion, the resin and the inner rovings and the wrapping or wrappings are compressed to form a polygonal cross section for engaging a correspondingly shaped chuck by which the bar can be rotated about a longitudinal axis of the bar.
